(19) United States
(12) Patent Application Publication
(10) Pub. No.: US 2011/0068172 A1
(43) Pub. Date: Mar. 24, 2011

(54) ROTARY ONE-DIMENSIONAL BARCODE READING DEVICE

(76) Inventor: KUO-SHEN LIU, Taipei (TW)

(21) Appl. No.: 12/564,059

(22) Filed: Sep. 22, 2009

(51) Int. Cl. G06K 7/10

(52) U.S. Cl. 235/462.2

(57) ABSTRACT

A rotary one-dimensional barcode reading device includes a motor and a one-dimensional barcode reader attached to the motor shaft so as to allow the reader to rotate with the motor shaft, by which linearity of the light source and the receiver of the barcode reader are converted into circularity to realize direction-diversified linear light sources and receives in various directions. Input and output of power source and signals are performed through electrical brushes. With this arrangement, a one-dimensional barcode in any direction can be properly read and the electronic signal generated by the one-dimensional barcode so read is transmitted through the electrical brushes or in a wireless manner to a computer, a point-of-sale (POS), a personal digital assistant (PDA), and the likes.

### (a) TECHNICAL FIELD OF THE INVENTION

The present invention generally relates to a rotary one-dimensional (1-D) barcode reading device, and more particularly to a direction-independent 1-D barcode reading device, which is realized by rotating an existing direction-dependent 1-D barcode reader with a motor.

### (b) DESCRIPTION OF THE PRIOR ART

One-dimensional (1-D) barcodes have been in existence for more than half a century. The general idea of the 1-D barcode reading is to irradiate a light source to a barcode and then receive the light reflected by the barcode, followed by converting the received reflection light into electronic signal. The electronic signal is then decoded by a decoder to determine the commodity associated therewith. The light source used include for example light-emitting diode (LED) and laser diode and the receiver for the reflection light include for example a charge-coupled device (CCD), a complementary metal-oxide semiconductor (CMOS) device, and a photo diode. General reading of a 1-D barcode requires setting the light source to completely cover the barcode, as shown in FIG. 1. It is often to make the light source, which is indicated by reference characters 02 in FIG. 1, a linear device. CCD and CMOS as employed in a receiver in this respect are also arranged as a linear CCD/CMOS sensor. Photo diode can be made movable with laser beam to also make a linear sensor. With such an arrangement, both the light source and the receiver have to be properly positioned in a manual manner to align the light source 02 in a direction normal to the barcode 01, as shown in FIG. 1, before reading can be properly carried out. The alignment is time-consuming and elaborate operation. To cope with such a problem, 1-D barcode readers that require no alignment, referring to as direction-independent barcode reader herein, is available and the operation principles are as follows:

(1) A laser is used as a light source. A polygonal mirror is rotated to re-direct and project a plurality of laser beams in various directions. At least one of the laser beams may get oriented substantially normal to the barcode to be read regardless the direction in which the barcode is positioned. Reading of the barcode can thus be done correctly. However, the mechanical arrangement is complicated and elaborate, making it very expensive.

(2) LEDs are used as light sources. Photographing means is taken to picture the whole barcode, which is received by a rectangular array of CCD or CMOS sensors to convert to an electronic signal. Numerous electronic signals are then analyzed to obtain the desired 1-D barcode signal. An example is shown in U.S. Pat. No. 7,428,991. The disadvantage is that a large number of light sources is needed in order to cover the whole area of the barcode. The CCD/CMOS sensor array is much more expensive than a linear CCD/CMOS sensor. Increasing the number of pixels makes the amount of signals to be analyzed increased and the decoder used must be upgraded or faster. All lead to high costs.

### SUMMARY OF THE INVENTION

A primary objective of the present invention is to provide a rotary one-dimensional (1-D) barcode reading device, wherein an existing direction-dependent 1-D barcode reader is manipulated with rotary motion performed by a motor to realize a direction-independent 1-D barcode reading device.

The rotary 1-D barcode reading device as described above comprises a motor and a 1-D barcode reader attached to the motor shaft so as to allow the reader to rotate with the motor shaft, by which linearity of the light source and the receiver of the barcode reader are converted into circularity to realize direction-diversified linear light sources and receives in various directions. Input and output of power source and signals are performed through electrical brushes. With this arrangement, a 1-D barcode in any direction can be properly read and the electronic signal generated by the 1-D barcode so read is transmitted through the electrical brushes or in a wireless manner to a computer, a point-of-sale (POS), a personal digital assistant (PDA), and the likes.

The rotary 1-D barcode reading device may comprise a plurality of electrical brushes and insulation must be made between the electrical brushes. Besides a grounding line of an electrical power source, other lines of the electrical power source must be arranged in such a way that an insulation ring is first fit over the shaft and a metal ring is further fit thereon. The wiring line of the metal ring must penetrate the insulation ring to connect to the barcode reader, or a hollow shaft is used to facilitate the wiring line to extend to and connect to the barcode reader. Alternatively, a shaft made of insulation may be adopted to omit the use of the insulation rings.

In the rotary one-dimensional barcode reading device described above, if a direct-current (DC) motor is taken as the motor that drives the shaft, the DC motor may share the same power source with the barcode reader.

In the rotary one-dimensional barcode reading device described above, an additional light source is provided to generate a light spot for aligning to a center of a barcode to be read so as to facilitate the reading of the barcode. The light spot will be off when the LED light source is on for eliminating interference.

In the rotary one-dimensional barcode reading device described above, the motor and the light source of the barcode reader can be arranged to power on at the same time or in an independent manner wherein due to the time period desired to completely actuate the motor, the motor can be kept in a condition of continuous rotation at a constant speed so as to improve the reading efficiency of barcodes. Alternatively, the light source can be arranged to power on only when a barcode is approaching.

In the rotary one-dimensional barcode reading device described above, the light source can be visible light or invisible light.

In the rotary one-dimensional barcode reading device described above, the barcode reading device can be arranged in a fixed type, a handheld type, or a gun type.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating reading a barcode in a conventional way.

FIG. 2 is a schematic view illustrating the structure of a rotary 1-D barcode reading device in accordance with a first embodiment of the present invention.

FIG. 3 is a schematic view illustrating the structure of a rotary 1-D barcode reading device in accordance with a second embodiment of the present invention.

FIG. 4 is a schematic view illustrating the structure of a rotary 1-D barcode reading device in accordance with a third embodiment of the present invention.

FIG. 5 is a schematic view illustrating the structure of a rotary 1-D barcode reading device in accordance with a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

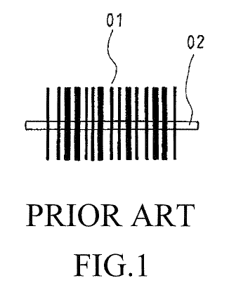

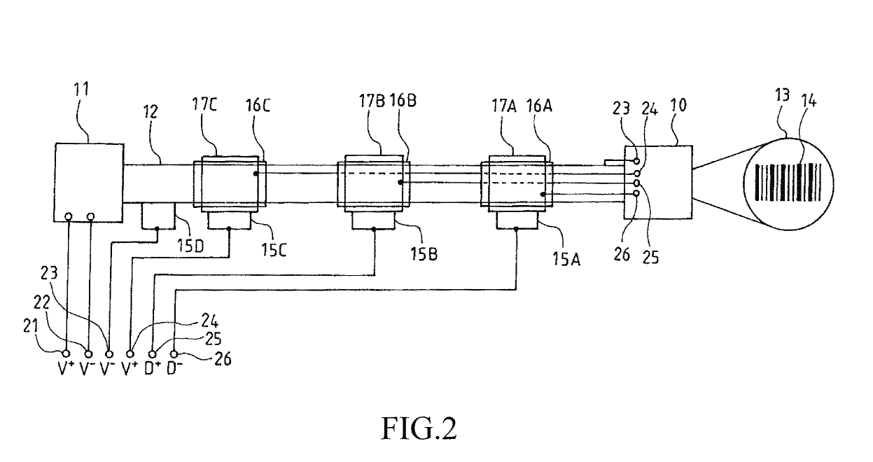

Referring to FIG. 2, a first embodiment of the present invention is shown. The present invention is constructed to comprise an existing direction-dependent 1-D barcode reader 10, which is known in the art, having a light source 02 that is linear and the same as that shown in FIG. 1. The linear light source 02 must be manipulated in a manual manner to align to the direction normal to a barcode 01 in order to read the barcode 01. The present invention mainly comprises a motor 11 and the shaft 12 mounted to the motor 11. The barcode reader 10 is mounted to the shaft 12, whereby when the motor 11 is put into rotation, the light source of the barcode reader 10 is converted from a linear form into a circular light irradiation surface 13 as shown in the drawing. The light irradiation surface 13 is sized to completely cover the barcode 14. Consequently, regardless of the direction in which the barcode 14 is positioned, the barcode 14 can be properly read. The light source used can be visible or invisible.

The present invention comprises electrical brushes 15A, 15B, 15C, 15D; insulation rings 16A, 16B, 16C, metal rings 17A, 17B, 17C; power lines 21, 22 for powering the motor 11; and power lines 23, 24 for powering the barcode reader 10. The power line 23 is a grounding line, which extends through the electrical brush 15D and the shaft 12 to the barcode reader 10. The power line 24 extends through the electrical brush 15C and the metal ring 16C and further penetrates through the insulation rings 16B and 16A to the barcode reader 10. Signal lines 25, 26 for output are further provided. The signal line 25 penetrates the insulation ring 16A to the metal ring 17B to realize output transmission through the electrical brush 15B, while the signal line 26 is connected to the metal ring 17A for output transmission through the electrical brush 15A. All the wires or lines must be insulation jacketed and the whole arrangement of the device can be a fixed type, a handheld type, or a gun type.

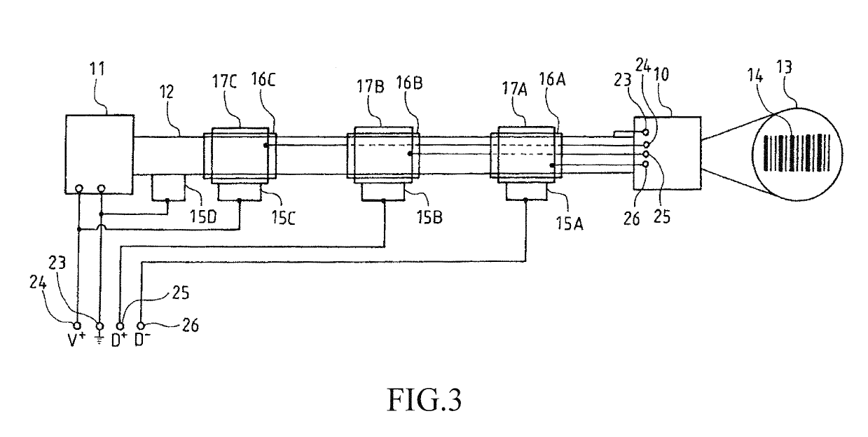

Referring to FIG. 3, in a second embodiment of the present invention, a direct-current (DC) motor is adopted. The DC motor may share the same power source with the barcode reader 10 and the wiring arrangement is illustrated in the drawing.

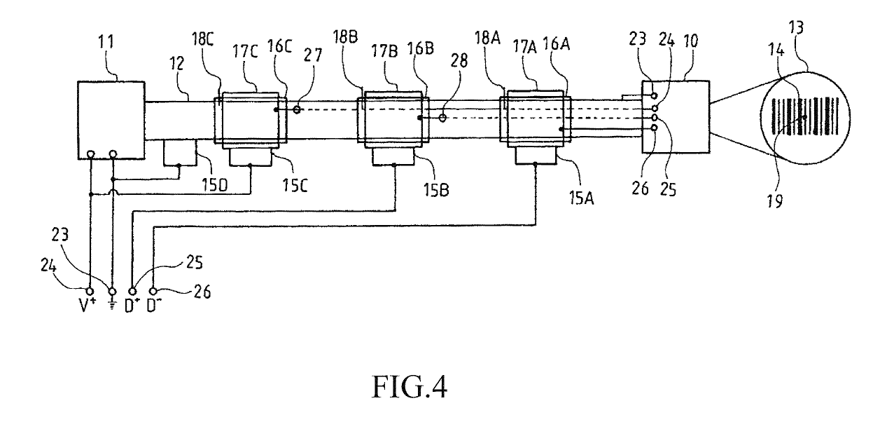

Referring to FIG. 4, in a third embodiment of the present invention, the shaft 12 is made hollow and the power line 24 extends through an aperture 27 into the hollow interior of the shaft 12. Similarly, the signal line 25 extends from the inside to the outside of the shaft 12 through an aperture 28. In this way, the insulation rings 16A, 16B can be past around. The manufacturing of the this arrangement may combine the insulation rings 16A, 16B, 16C together as a unitary member. Or alternatively, a shaft made of insulation substance may be used and in this case, the insulation rings 16A, 16B, 16C can be omitted. The metal rings 17A, 17B, 17C can be mounted by adhesives or can alternatively fixed in the manner shown in the drawing with pins 18A, 18B, 18C.

Referring to FIG. 4, the present invention may further comprises a laser light source that project a laser beam to a center of a barcode to be read as a pointing light spot 19 to facilitate reading. It will be switched off when the LED light source is switch on for eliminating interference.

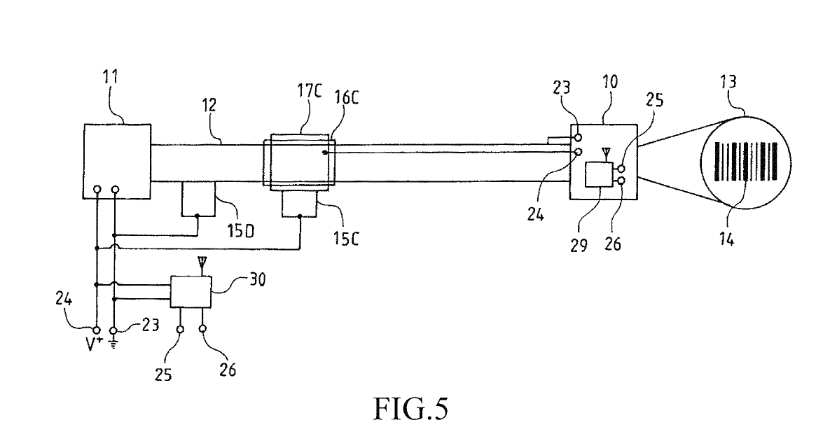

Referring to FIG. 5, in a fourth embodiment of the present invention, wireless devices 29 and 30 are adopted to transmit and receive signal of the barcode read with radio signals.

In operation, the motor 11 and the light source 02 can be powered on at the same time. Or alternatively, the motor 11 can be activated to rotate at a constant speed and the light source 02 is powered on only when a barcode is to be read. Or alternatively, a proximity sensor may be used so that the light source 02 may be automatically powered on when a barcode is approaching.

The various embodiments illustrated above are example preferred forms for embodying the present invention and are not intended to constrain the scope of the present invention.

To summarize, the present invention mounts a barcode reader to motor shaft so that an existing direction-dependent 1-D barcode reader is converted into a direction-independent 1-D barcode reader through the rotation of the motor shaft. This is a novel arrangement that has never been proposed before.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A rotary one-dimensional barcode reading device, comprising a motor and shaft coupled to the motor, a barcode reader being attached to the shaft to rotate with the shaft, whereby the barcode reader is allowed to read a one-dimensional barcode set in any direction so as to realize reading of one-dimensional barcode in a direction independent manner.

2. The rotary one-dimensional barcode reading device according to claim 1, wherein input of electrical power to the barcode reader is realized through an electrical brush.

3. The rotary one-dimensional barcode reading device according to claim 1, wherein output of a signal of the barcode so read is realized through an electrical brush or wireless radio transmission.

4. The rotary one-dimensional barcode reading device according to claim 2, wherein power lines that supply the input of the electrical power of the barcode readers are insulation isolated and wherein except a grounding line of the electrical power, other lines of the electrical power are arranged in such a way that an insulation ring is first fit over the shaft and a metal ring is further fit thereon to connect an electrical brush.

5. The rotary one-dimensional barcode reading device according to claim 3, wherein the output signal lines of the barcode readers are insulation isolated and arranged in such a way that an insulation ring is first fit over the shaft and a metal ring is further fit thereon to connect an electrical brush.

6. The rotary one-dimensional barcode reading device according to claim 1, wherein the motor comprises a direct-current motor and wherein the direct-current motor shares the power lines with the barcode reader.

7. The rotary one-dimensional barcode reading device according to claim 4, wherein the metal rings are fixed by adhesives or pins.

8. The rotary one-dimensional barcode reading device according to claim 4, wherein the power lines and the signal lines are insulation jacketed.

9. The rotary one-dimensional barcode reading device according to claim 1, wherein the shaft is hollow and wherein one of the lines extends into hollow interior of the shaft through an aperture formed in the shaft so as to pass over the electrical brushes, the insulation rings being combined as a unitary member.

10. The rotary one-dimensional barcode reading device according to claim 1, wherein the shaft is made of insulation so as to allow the insulation rings to be omitted and also allow the lines to pass over the electrical brushes.

11. The rotary one-dimensional barcode reading device according to claim 1, wherein the motor and the light source of the barcode reader are powered on at the same time or the motor is powered on first and keeps a constant speed of rotation and then the light source is selectively powered on at the time when a barcode is to be read.

12. The rotary one-dimensional barcode reading device according to claim 1, wherein a proximity sensor is provided to automatically power on the light source when a barcode is approaching.

13. The rotary one-dimensional barcode reading device according to claim 1, wherein the light source comprises a laser that is used to irradiate a center of a barcode to be read to form a pointing light spot to facilitate aiming to the center of the barcode and thus improving reading of the barcode and the laser will be switch off when LED light source is switch on for eliminating interference.

14. The rotary one-dimensional barcode reading device according to claim 1, wherein the light source is visible light or invisible light.

15. The rotary one-dimensional barcode reading device according to claim 1, wherein the barcode reading device is arranged in a fixed type, a handheld type, or a gun type.
